(19) United States
(12) Patent Application Publication
(10) Pub. No.: US 2003/0138239 A1
(43) Pub. Date: Jul. 24, 2003

(54) Method of recording image data and apparatus for doing the same

(75) Inventor: Satoshi Itoi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/347,617

(22) Filed: Jan. 22, 2003

(30) Foreign Application Priority Data
Jan. 23, 2002 (JP) 2002-014194
Jun. 12, 2002 (JP) 2002-171521

(51) Int. Cl. H04N 5/781

(52) U.S. Cl. 386/95; 386/125; 386/111

(57) ABSTRACT

A method of recording image data includes the steps of (a) recording image audio stream data as one stream data file, (b) recording navigation data as one navigation data file, (c) recording private data as one or more private data file(s), and (d) recording at least one of (d1) table data included in a stream and (d2) descriptor(s) included in the table data, into a first or second area in the private data file, the stream data file or the navigation data file, wherein the first area is defined as an area into which character data is to be recorded, and the second area is defined as an area into which private data is to be recorded.

### BACKGROUND OF THE INVENTION

1. Field of the Invention

The invention relates to a method of transferring or recording image data in a DVD stream recorder, a DVD video recorder, and a hard disk video recorder, an apparatus for doing the same, and a recording medium recording data therein in accordance with the above-mentioned method.

2. Description of the Related Art

As a stream or video related application format in DVD (digital versatile disc), there have been standardized DVD-SR (Stream Recording), DVD-VR (Video Recording) and a DVD-Video format in DVD-Forum.

DVD-SR is a format for recording data having been received as MPEG stream, basically as it is, and has a main target in recording digital-broadcasting. DVD-VR is a format for digitizing analog video, MPEG-2 encoding the digitized analog video, and recording, and has a main target in a video camera and recording analog-broadcasting. DVD-Video is a format only for reproducing a disc into which a content such as a movie has been already recorded, and has a main target in home theater.

Presently, DVD-Video is available worldwide as an article of commerce, and DVD-VR is now spreading worldwide. Though DVD-SR is not available yet as an article of commerce, it is very promising as a recording format, if broadcasting transfers to digital one from analog one.

In DVD-SR, a stream data file such as image or audio data is determined as SR_TRANS. SRO, a navigation data file used for editing data or reproducing data in a specific way is determined as SR_MANGR. IFO, and a private data file is determined as SR_PRIVT. DAT. In a present format, data is recorded in SR_TRANS. SRO and/or SR_MANGR. IFO files.

However, a method of recording stream data in accordance with DVD-SR is accompanied with the following problems.

When an apparatus for recording digitally broadcast data is to be fabricated as an article of commerce, some data cannot be determined as to in which part in a format it should be recorded.

SR_TRANS. SRO, SR_MANGR. IFO, and SR_PRIVT. DAT files are defined in DVD-SR. However, if a user would like to continuously watch or listen to only data such as following data (a) to (k), and hence, record only the data separately from a stream, the above-mentioned three files do not define any rules for doing so. Thus, each of recorder manufacturers defines a rule for recording such data at its own discretion, resulting in no compatibility among recorders fabricated by those recorder manufacturers.

(a) table data such as PAT (Program Association Table) defined by MPEG, and a descriptor such as a descriptor for receiving only predetermined data,

(b) table data of program arrangement data defined by ARIB, extended table data defined by ARIB, table data other than table data of program arrangement data defined by ARIB, and a descriptor or descriptors included in those table data,

(c) table data defined by DVB, and a descriptor or descriptors included in the table data,

(d) table data defined by ATSC, and a descriptor or descriptors included in the table data,

(e) internet data associated with a data file recorded in a recording medium such as a disc,

(f) updated and hence latest news, and a weather report,

(g) a resume marker,

(h) typical image among a data file recorded in a recording medium such as a disc,

(i) vide attribute data, audio attribute data, and sub-picture attribute data,

(j) thumbnail data used for retrieving video data, and a frame number and header data of an audio frame used for retrieving audio data, and

(k) data broadcasting and audio broadcasting.

If a user converts a format of a content recorded in accordance with DVD-SR into a format of a DVD-VR player or a DVD-Video player in order to watch or listen to the contents through a DVD-VR player or a DVD-Video player, he/she cannot do so readily. The reason is as follows.

DVD-SR includes a map used for retrieving, reproducing and editing data which map describes a relation between a time and SOBU (Stream OBject Unit) having a fixed capacity of 64 kB. In contrast, DVD-VR and DVD-Video includes a map which describes a relation among VOBU (Video OBject Unit) having a non-fixed capacity defined by data compression, an address, and a time. Each time a format is requested to be converted, those two maps are converted over all data. The same is applied to conversion to DVD-SR from DVD-VR or DVD-Video.

Japanese Unexamined Patent Publication No. 11-31362 has suggested a digital disc including a plurality of audio streams associated with titles. Among the audio streams associated with titles, a specific audio stream includes basic audio data having a DVD-Video format, and at least one of the rest of the audio streams includes extended audio data associated with the basic audio data. The digital disc includes at least one title including additional data which identifies extended audio data including a video title set having audio stream attribute related at least one extended audio stream. The basic audio data provides audio quality defined in accordance with the DVD-Video format, and the extended audio data provides audio quality superior to the audio quality defined in accordance with the DVD-Video format.

Japanese Unexamined Patent Publication No. 2000-21089 has suggested a storage unit including an analog-digital converter which converts an analog audio signal into a digital signal having a predetermined sampling frequency and the predetermined number of bits, first means for providing attribute data to the digital signal, and converting a format of the digital signal into a predetermined format, second means for recording the digital signal into an optic recording medium, an controller for controlling an operation of the analog-digital converter, the first means and the second means, and third means for inputting commands to the controller therethrough.

However, the above-mentioned problem remains unsolved even in those Publications.

### SUMMARY OF THE INVENTION

In view of the above-mentioned problems in the conventional methods and apparatuses, it is an object of the present invention to provide a method of recording image data, a method of transferring image data, a method of receiving and recording image data, and apparatuses for doing the same, all of which are capable of readily converting a format of data to DVD-VR or DVD-Video from DVD-SR, or converting a format of data to DVD-SR from DVD-VR or DVD-Video.

In one aspect of the present invention, there is provided a method of recording image data, including the steps of (a) recording image audio stream data as one stream data file, (b) recording navigation data as one navigation data file, (c) recording private data as one or more private data file(s), and (d) recording at least one of (d1) table data included in a stream and (d2) descriptor(s) included in the table data, into a first or second area in the private data file, the stream data file or the navigation data file, wherein the first area is defined as an area into which character data is to be recorded, and the second area is defined as an area into which private data is to be recorded.

It is preferable that the table data includes at least one of PSI (Program Specific Information) data defined by MPEG (Moving Picture Expert Group) and table data indicative of program arrangement produced by ARIB (Association of Radio Industries and Business) as standard for digital-broadcasting, and the descriptor(s) includes a descriptor or descriptors defined by MPEG and a descriptor or descriptors produced by ARIB as standard for digital-broadcasting.

It is preferable that the table data includes at least one of extended table data produced by ARIB as standard for digital-broadcasting and table data other than able data indicative of program arrangement produced by ARIB as standard for digital-broadcasting, and the descriptor(s) includes a descriptor or descriptors included in the extended table data and a descriptor or descriptors included in the table data other than able data indicative of program arrangement produced by ARIB as standard for digital-broadcasting.

It is preferable that the table data includes table data defined by DVB (Digital Video Broadcasting), and the descriptor(s) includes a descriptor or descriptors included in table data defined by DVB.

It is preferable that the table data includes table data defined by ATSC (Advanced Television System Committee), and the descriptor(s) includes a descriptor or descriptors included in table data defined by ATSC.

It is preferable that the stream data file is defined as SR_TRANS. SRO defined by DVD-SR format, the navigation data file is defined as SR_MANGR. IFO defined by DVD-SR format, and the private data file is defined as SR_PRIVT. DAT defined by DVD-SR format.

There is further provided a method of recording image data, including the steps of (a) recording image audio stream data as one stream data file, (b) recording navigation data as one navigation data file, (c) recording private data as one or more private data file(s), and (d) recording at least one of video attribute data, audio attribute data and sub-picture attribute data into a first or second area in the private data file, the stream data file or the navigation data file, wherein the first area is defined as an area into which character data is to be recorded, and the second area is defined as an area into which private data is to be recorded.

It is preferable that the video attribute data includes at least one of (a) a method of compressing data, (b) the number of scanning lines per a frame, (c) an aspect ratio, (d) status of recording user data into the first field, the twenty-first line, (e) status of recording user data into the second field, the twenty-first line, (f) the number of effective pixels per a line and the number of effective lines per a frame, (g) the number of audio stream, and (h) the number of sub-picture stream.

It is preferable that the audio attribute data includes at least one of (a) encoding mode, (b) the number of quantized bits, (c) whether dynamic range control is carried out or not, (d) a sampling frequency, (e) the number of audio channels, (f) an application flag, (g) a bit rate, (h) indication as to whether the audio attribute data is original or dummy, (i) an analog copy protection type, (j) a seamless flag, and (k) whether there is audio gap or not.

It is preferable that the sub-picture attribute data includes color data of a brightness signal and a color signal.

There is still further provided a method of recording image data, including the steps of (a) recording image audio stream data as one stream data file, (b) recording navigation data as one navigation data file, (c) recording private data as one or more private data file(s), and (d) recording (d1-a) thumbnail data, and an address to jump into when the thumbnail address is selected, or (d1-b) a header address of picture data recorded as thumbnail data existing in a stream, and (d2) character data associated with the thumbnail data, the address and the header address, into a first or second area in the private data file, the stream data file or the navigation data file for retrieving video data, wherein the first area is defined as an area into which character data is to be recorded, and the second area is defined as an area into which private data is to be recorded.

It is preferable that a frame number of a header audio frame in each of retrieval, an address in which header audio frame data is recorded, and character data associated with the frame number and the address are recorded in the first or second area for retrieving audio data.

There is yet further provided a method of recording image data, including the steps of (a) recording image audio stream data as one stream data file, (b) recording navigation data as one navigation data file, (c) recording private data as one or more private data file(s), and (d) recording at least one of data broadcasting and audio broadcasting into a first or second area in the private data file, the stream data file or the navigation data file, wherein the first area is defined as an area into which character data is to be recorded, and the second area is defined as an area into which private data is to be recorded.

There is further provided a method of recording image data, including the steps of (a) recording image audio stream data as one stream data file, (b) recording navigation data as one navigation data file, (c) recording private data as one or more private data file(s), (d) converting search data recorded in the navigation data file in a stream-recording format into search data in an image-recording format or in a format only for reproducing image data, and (e) recording the search data resulted from the step (d) into a first or second area in the private data file, the stream data file or the navigation data file, wherein the first area is defined as an area into which character data is to be recorded, and the second area is defined as an area into which private data is to be recorded.

The method may further include the steps of converting data used for reproducing data at a variable rate and recorded in the navigation data file in a stream-recording format is into data used for reproducing data at a variable rate, in an image-recording format or in a format only for reproducing image data, and recording the thus converted data into the first or second area.

The method may further include the steps of converting cell data used for editing data and recorded in the navigation data file in a stream-recording format converted into cell data used for editing data, in an image-recording format or in a format only for reproducing image data, and recording the thus converted data into the first or second area.

The method may further include the steps of (f) extracting search data, data used for reproducing data at a variable rate and cell data used for editing data, out of data having an image-recording format or a format only for reproducing image data, (g) recording the thus extracted data into the first or second area, (h) converting image audio data having an image-recording format or a format only for reproducing image data, into image audio data having a stream-recording format, and (i) recording image audio stream and navigation data as a stream data file and a navigation data file, respectively, the steps (g) and (i) being to be concurrently carried out.

There is further provided a method of recording image data, including the steps of (a) recording image audio stream data as one stream data file, (b) recording navigation data as one navigation data file, (c) recording private data as one or more private data file(s), and (d) recording at least a part of internet data, director's cut, director's comment data, internet shopping data, chat data, and streaming data all associated with a data file recorded in accordance with the present method, into a first or second area, wherein the first area is defined as an area into which character data is to be recorded, and the second area is defined as an area into which private data is to be recorded.

There is provided a method of recording image data, including the steps of (a) recording image audio stream data as one stream data file, (b) recording navigation data as one navigation data file, (c) recording private data as one or more private data file(s), and (d) recording at least a part of news including traffic, sport and a stock price, and a weather forecast into a first or second area, wherein the first area is defined as an area into which character data is to be recorded, and the second area is defined as an area into which private data is to be recorded.

The method may further include the step of manually or automatically updating the news and the weather forecast.

There is further provided a method of recording image data, including the steps of (a) recording image audio stream data as one stream data file, (b) recording navigation data as one navigation data file, (c) recording private data as one or more private data file(s), and (d) recording at least a part of a program number in which a resume marker is set, a program chain number, a cell number, a point, date and time at which a marker was fabricated, a sector address, and character data associated with those into a first or second area, wherein the first area is defined as an area into which character data is to be recorded, and the second area is defined as an area into which private data is to be recorded.

There is further provided a method of recording image data, including the steps of (a) recording image audio stream data as one stream data file, (b) recording navigation data as one navigation data file, (c) recording private data as one or more private data file(s), and (d) recording at least a part of a program number of typical image of a data file recorded in accordance with the present method, a cell number, a point, date and time at which the typical image was produced, a sector address, and character data associated with those into a first or second area, wherein the first area is defined as an area into which character data is to be recorded, and the second area is defined as an area into which private data is to be recorded.

There is further provided a method of transferring image data, wherein when at least one of an image audio stream data file, a navigation data file and a private data file all recorded in accordance with the method of recording image data is(are) transferred through a common interface, the image audio stream data file is transferred in a mode in which a minimum transfer rate is guaranteed, and the navigation data file and the private data file are transferred in a mode in which a minimum transfer rate is not guaranteed.

There is further provided a method of transferring image data, wherein when an image audio stream data file, a navigation data file and a private data file all recorded in accordance with the above-mentioned method of recording image data are transferred separately from one another.

There is further provided a method of transferring image data, wherein when an image audio stream data file recorded in accordance with the above-mentioned method of recording image data is transferred through a line, and data into which at least one of a navigation data file and a private data file both recorded in accordance with the above-mentioned method of recording image data is(are) multiplexed transferred through another line.

There is further provided a method of receiving and recording image data, including the steps of (a) receiving data having been transferred in accordance with the above-mentioned method of transferring image data, (b) converting a data file of the received data, having a stream-recording format, into a data file having an image-recording format or a data file having a format used only for reproducing image data, and (c) recording the received data in the thus converted format.

There is further provided a method of receiving and recording image data, including the steps of (a) receiving a data file having an image-recording format or a format used only for reproducing image data,

(b) converting the thus received data file into a data file having a stream recording format, and (c) recording the thus converted data file in accordance with the above-mentioned method of recording image data.

It is preferable that the stream-recording format is DVD-SR (Stream Recording), the image-recording format is DVD-VR (Video Recording), and the form used only for reproducing image is DVD-Video format.

In another aspect of the present invention, there is provided a recorder for recording at least one of image audio stream data, navigation data and private data therein in accordance with the above-mentioned method of recording image data.

There is provided an apparatus for transferring at least one of image audio stream data, navigation data and private data in accordance with the above-mentioned method of transferring image data.

There is provided an apparatus for receiving and recording at least one of image audio stream data, navigation data and private data in accordance with the method of receiving and recording image data.

In still another aspect of the present invention, there is provided a recording medium readable by a computer, into which at least one of a stream data file, a navigation data file and a private data file is(are) recorded in accordance with the above-mentioned method of recording image data.

There is provided a recording medium readable by a computer, into which at least one of image audio stream data, navigation data and private data is(are) recorded therein in accordance with the above-mentioned method of transferring image data.

The advantages obtained by the aforementioned present invention will be described hereinbelow.

When a user would like to continuously watch or listen to only data such as the above-mentioned data (a) to (k), and hence, record the data separately from a stream, the present invention presents compatibility with recorders fabricated by other recorder manufacturers, and accomplishes high-quality retrieval, reproduction and edition of contents. This is because the present invention defines a format for recording data, and records data into a character data recording area or a private data recording area in the private data file SR_PRIVT. DAT, the stream data file SR_TRANS. SRO or the navigation data file SR_MANGR. IFO.

In accordance with the present invention, when a content having a DVD-SR format is converted in format into a DVD-VR or DVD-Video format in order to watch or listen to the content through a DVD-VR or DVD-Video player, a map which describes a relation among VOBU (Video OBject Unit) having a non-fixed capacity defined by data compression, an address, and a time is made, based on a map which describes a relation between a time and SOBU (Stream OBject Unit) having a fixed capacity of 64 kB. Map information is further made by converting address data recording seconds-later data therein, based on the same. The map and map information are recorded into a character data recording area or a private data recording area in the private data file SR_PRIVT. DAT, the stream data file SR_TRANS. SRO or the navigation data file SR_MANGR. IFO.

Thus, it would be possible for a user to watch or listen to a content having been recorded in accordance with a DVD-SR format, through a DVD-VR or DVD-Video player.

In addition, it would be also possible, by transmitting data to or receiving data from the private data file SR_PRIVT. DAT, the stream data file SR_TRANS. SRO or the navigation data file SR_MANGR. IFO through a digital interface, to produce DVD-VR and DVD-Video data, and record those data into a memory in a DVD-VR or DVD-Video format. Further, it would be possible to convert a format of data having been input in a DVD-VR or DVD-Video format, into a DVD-SR format, and record the data in a DVD-SR format.

In addition, the present invention makes it possible to convert a format of a content having been recorded in a DVD-VR or DVD-Video format, into a DVD-SR format, and record the content in a DVD-SR format.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a DVD-SR recorder in accordance with a preferred embodiment of the present invention.

FIG. 2 illustrates SOBU and IAPAT in a DVD-SR format.

FIG. 3 illustrates time entry and VOBU entry in a DVD-VR format.

FIG. 4 illustrates an example of AUSM and SOBUs associated with AUSM.

FIG. 5 illustrates an example of AUSM and AUEM.

FIG. 6 illustrates a stream pack defined in accordance with DVD-SR.

FIG. 7 illustrates a video pack defined in accordance with DVD-VR and DVD-Video.

FIG. 8 illustrates an example in which the video pack illustrated in FIG. 7 is generated from the stream pack illustrated in FIG. 6.

### DESCRIPTION OF THE PREFERRED EMBODIMENT

A preferred embodiment in accordance with the present invention will be explained hereinbelow with reference to drawings.

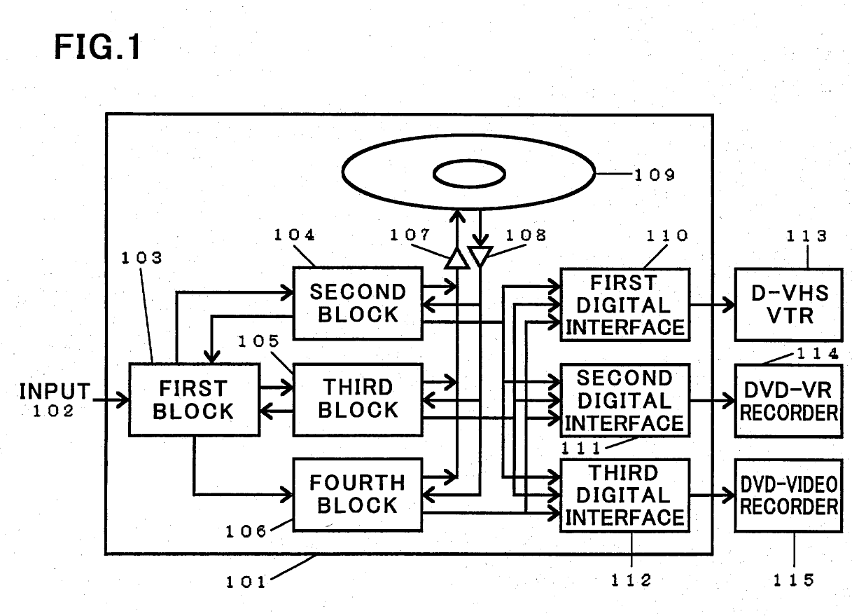

FIG. 1 is a block diagram of a DVD-SR recorder 10 in accordance with a preferred embodiment of the present invention.

The DVD-SR recorder 10 is comprised of a first block 103, a second block 104, a third block 105, a fourth block 106, a first circuit 107 for recording data into a disc 109 having been inserted into the DVD-SR recorder 10, a second circuit 108 for reproducing data recorded in the disc 109, a first digital interface 110, a second digital interface 111, and a third digital interface 112.

The first block 103 has a function of producing a file and converting a format of data.

The second block 104 has a function of producing and detecting a SR_MANGR. IFO file.

The third block 105 has a function of producing and detecting a SR_TRANS. SRO file.

The fourth block 106 has a function of producing and detecting a SR_PRIVT. DAT file.

The first digital interface 110 receives SR_MANGR. IFO, SR_TRANS. SRO and SR_PRIVT. DAT files, produces data defined in accordance with IEEE 1394, and then, outputs the thus produced data to a D-VHS VTR 113.

The second digital interface 111 receives SR_MANGR. IFO, SR_TRANS. SRO and SR_PRIVT. DAT files, produces data defined in accordance with DVD-VR, and then, outputs the thus produced data to a DVD-VR recorder 114.

The third digital interface 112 receives SR_MANGR. IFO, SR_TRANS. SRO and SR_PRIVT. DAT files, produces data defined in accordance with DVD-Video, and then, outputs the thus produced data to a DVD-Video recorder 115.

It is assumed that data is recorded in the disc 109 in accordance with a DVD-SR format, stream data having a DVD-SR format is recorded in the SR_TRANS. SRO file, and navigation data having a DVD-SR format is recorded in the SR_MANGR. IFO file. The disc 109 does not include the SR_PRIVT. DAT file.

The second circuit 108 reproduces data out of the disc 109, and transmits the thus reproduced data to the second and third blocks 104 and 105. The second and third blocks 104 and 105 detect navigation data and stream data in the data received from the second circuit 108. The detected navigation and stream data are transmitted to the fourth block 106 through the first block 103.

The fourth block 106 detects table data such as PAT (Program Association Table) and a descriptor such as one describing limited data to be received, in the data received from the first block 103 and the second circuit 108, and records the thus detected data into a memory (not illustrated).

Similarly, the fourth block 106 detects table data such as PAT (Program Association Table) defined in accordance with MPEG, table data of program arrangement data such as NIT (Network Information Table) defined in accordance with ARIB, extended table data such as LIT (Local event Information Table), table data other than table data of program arrangement data, such as ECM (Entitlement Control Message), and a descriptor such as a basic local event descriptor, and writes the thus detected data into the memory (not illustrated).

Similarly, the fourth block 106 detects table data defined in accordance with DVB, and a descriptor or descriptors included in the table data, and then, records the thus detected data into the memory (not illustrated).

Similarly, the fourth block 106 detects table data defined in accordance with ATSC, and a descriptor or descriptors included in the table data, and then, records the thus detected data into the memory (not illustrated).

Similarly, the fourth block 106 detects internet data concerning the disc 109, and then, records the thus detected data into the memory (not illustrated).

Similarly, the fourth block 106 detects updated and hence latest news and weather report, and then, records the thus detected data into the memory (not illustrated).

Similarly, the fourth block 106 detects a resume marker, and then, records the thus detected resume marker into the memory (not illustrated).

Similarly, the fourth block 106 detects typical image among images recorded in the disc 109, and then, records the thus detected image into the memory (not illustrated).

Similarly, the fourth block 106 detects video audio sub-picture attribute data, and then, records the thus detected data into the memory (not illustrated).

Further, the fourth block 106 detects (a) thumbnail data, and an address to jump into when the thumbnail address is selected, or a header address of picture data recorded as thumbnail data existing in a stream, (b) character data associated with the thumbnail data, the address and the header address, a frame number of an audio frame used for retrieving audio data, and data of a header audio frame, and (c) character data associated with the frame number and the data of a header audio frame, and then, records the thus detected data into the memory (not illustrated).

Further, the fourth block 106 detects data broadcasting and audio broadcasting, and records them into the memory (not illustrated).

The first and fourth blocks 103 and 106 produce a map (VOBU entry) which describes a capacity and a time for each of VOBUs having a non-fixed capacity determined by a unit of compression, and which is defined in accordance with a DVD-VR format, a top VOBU number for each of predetermined period of time starting from a head of VOB (Video Object), a VOBU address, and a map (time entry) describing a difference in time between TMU boundary and VOBU boundary, based on a map (mapping list) which describes a period of time for each of SOBUs having a fixed capacity of 64 kB and which is defined in accordance with a DVD-SR format, and records the thus produced data into the memory (not illustrated).

Further, the first and fourth blocks 103 and 106 produce a time map in which a time interval in map entry, a sector address of a top VOBU in the map entry, and a first sector addresses in all VOBUs are recorded, and which is defined in accordance with a DVD-Video format, and records the thus produced data and numbers into the memory (not illustrated). The time map and a method of converting a format will be explained later in detail.

Further, the first and fourth blocks 103 and 106 produce 1STREF_SZ (I picture size) defined in accordance with a DVD-VR format, based on AUSM (Access Unit Start Map) and AUEM (Access Unit End Map) both defined in accordance with a DVD-SR format, and records the thus produced data and numbers into the memory (not illustrated).

Further, the first and fourth blocks 103 and 106 produce address data navigation pack (NV_PCK) which is defined in accordance with a DVD-Video format and in which pre-VOBUs and post-VOBUs data are recorded, and records the navigation pack into the memory (not illustrated).

Further, the first and fourth blocks 103 and 106 produce a cell defined in accordance with a DVD-VR format, based on a stream cell defined in accordance with a DVD-SR format, and records the thus produced cell into the memory (not illustrated).

Further, the first and fourth blocks 103 and 106 produce a cell defined in accordance with a DVD-Video format, based on a stream cell defined in accordance with a DVD-SR format, and records the thus produced cell into the memory (not illustrated).

The fourth block 106 reads the above-mentioned data out of the memory, and produces a SR_PRIVT. DAT file. Then, the fourth block 106 records the SR_PRIVT. DAT file into the disc 109 through the first circuit 107.

A structure of the SR_PRIVT. DAT file will be explained in detail later.

The stream data file SR_TRANS. SRO, navigation data file SR_MANGR. IFO, and private data file SR_PRIVT. DAT recorded in the DVD-SR recorder 101 are read out of the disc 109 through the second circuit 108, and then, output to the D-VHS VTR 113, the DVD-VR recorder 114 and the DVD-Video recorder 115 through the first, second and third digital interfaces 110, 111 and 112, respectively.

For instance, the D-VHS VTR 113 may be replaced with a hard-disc recorder, and the DVD-VR recorder 114 may be replaced with another DVD-SR recorder. When the DVD-VR recorder 114 is replaced with another DVD-SR recorder, the SR_TRANS. SRO, SR_MANGR. IFO, and SR_PRIVT. DAT files are output as they are to the another DVD-SR recorder. In contrast, the SR_TRANS. SRO, SR_MANGR. IFO, and SR_PRIVT. DAT files are output to the D-VHS VTR 113, the DVD-VR recorder 114 and the DVD-Video recorder 115 in an optimal interface format. Each of the D-VHS VTR 113, the DVD-VR recorder 114 and the DVD-Video recorder 115 receives interface data in an optimal format, converts a format of the received interface data to a format associated therewith, and records the received interface data therein.

The D-VHS VTR 113, the DVD-VR recorder 114 and the DVD-Video recorder 115 may transmit data having an interface format, to the DVD-SR recorder 101. On receipt of the data, the DVD-SR recorder 101 converts a format of the received data into a DVD-SR format, and then, records SR_TRANS. SRO, SR_MANGR. IFO, and SR_PRIVT. DAT files in the disc 109.

The interfaces will be explained in detail later.

Hereinbelow is explained an example of data arrangement to a SR_PRIVT. DAT file.

First, table data and a descriptor or descriptors included in the table data are arranged in the SR_PRIVT. DAT file.

The table data includes PAT (Program Association Table), CAT (Conditional Access Table) and PMT (Program Map Table) comprised of PSI (Program Specific Information) data defined in accordance with MPEG (Moving Picture Expert Group).

The table data further includes NIT (Network Information Table), BAT (Bouquet Association Table), SDT (Service Description Table), EIT (Event Information Table), RST (Running Status Table), TDT (Time and Data Table), TOT (Time Offset Table), PCAT (Partial Content Announcement Table), ST (Stuffing Table), BIT (Broadcaster Information Table), NBIT (Network Broad Information Table) and LDT (Linked Description Table) all defined as program arrangement data of digital broadcasting in accordance with ARIB (Association of Radio Industries and Businesses), as well as the above-mentioned PAT, CAT and PMT defined in accordance with PSI.

A descriptor includes a descriptor which receives only limited data, and a copyright descriptor both defined in accordance with MPEG.

A descriptor further includes a network name descriptor, a service list descriptor, a stuff descriptor, a satellite distributing system descriptor, a bouquet name descriptor, a service descriptor, a descriptor for allowing to receive data from predetermined countries, a link descriptor, a NVOD standard service descriptor, a time-shift service descriptor, a short-type event descriptor, an extension-type event descriptor, a time-shift event descriptor, a component descriptor, a mosaic descriptor, a stream-identifying descriptor, a CA-identifying descriptor, a content descriptor, a parental rate descriptor, a hierarchy transfer descriptor, a digital copy control descriptor, an urgent warning broadcasting descriptor, a data-encoding descriptor, a system administrating descriptor, a local time offset descriptor, a voice component descriptor, a hyperlink descriptor, a target area descriptor, a data content descriptor, a video code control descriptor, on-earth distribution system descriptor, a partial reception descriptor, a series descriptor, an event group descriptor, a SI transfer parameter descriptor, a broadcaster name descriptor, a component group descriptor, a SI prime TS descriptor, a notice-board data descriptor, a LDT link descriptor, and a link-transmission descriptor, all defined in accordance with ARIB, as well as the above-mentioned two descriptors defined in accordance with MPEG.

Such data as mentioned above may be recorded by making a copy of the data multiplexed to a stream, and storing the copy into the SR_PRIVT. DAT file. As an alternative, such data as mentioned above may be recorded by transferring data multiplexed to a stream, into the SR_PRIVT. DAT file.

When the data is reproduced, program arrangement data can be rapidly detected by continuously reproducing only the above-mentioned table data and descriptor.

Hereinbelow is explained another example of data arrangement to the SR_PRIVT. DAT file.

Extended table data defined in accordance with ARIB, table data other than program arrangement data defined in accordance with ARIB, and a descriptor or descriptors included in those table data are arranged in the SR_PRIVT. DAT file.

The extended table data includes LIT (Local event Information Table), ERT (Event Relation Table), ITT (Index Transmission Table) and so on. These table data are defined for BS digital broadcasting standard or CS digital broadcasting standard in accordance with ARIB.

The table data other than program arrangement data includes ECM (Entitlement Control Message), EMM (Entitlement Management Message), DCT (Download Control Table), DLT (DownLoad Table), DIT (Discontinuity Information Table), SIT (Selection Information Table), SDTT (Software Download Trigger Table), a DSM-SS section, and so on. These table data are also defined for BS digital broadcasting standard or CS digital broadcasting standard in accordance with ARIB.

The descriptor includes a basic local event descriptor, a reference descriptor, a node-related descriptor, a short-type node data descriptor, an STC reference descriptor, and so on. These descriptors are defined for BS digital broadcasting standard or CS digital broadcasting standard in accordance with ARIB.

The same as mentioned above is applied to DVB. Table data defined in accordance with DVB are arranged.

The same as mentioned above is applied to ATSC. The table data includes MGT (Master Guide Table), STT (System Time Table), VCT (Virtual Channel Table), RRT (Rating Region Table), EIT (Event Information Table), ETT (Extended Text Table), and so on.

Such data as mentioned above may be recorded by making a copy of the data multiplexed to a stream, and storing the copy into the SR_PRIVT. DAT file. As an alternative, such data as mentioned above may be recorded by transferring data multiplexed to a stream, into the SR_PRIVT. DAT file.

When the data is reproduced, program arrangement data can be rapidly detected by continuously reproducing only the above-mentioned table data and descriptor.

Hereinbelow is explained an example of data arrangement to the SR_PRIVT. DAT file.

Internet data concerning a data file recorded in a recording medium such as a disc is arranged in the SR_PRIVT. DAT file.

When a user watches or listens to a content through a DVD-Video recorder, it is possible to transmit various data to or receive various data from internet in synchronization with the content. Examples thereof are explained hereinbelow.

(a) Director's Cut

A scene or cut of which a director particularly took a photograph can be received from internet, and displayed in a monitor in synchronization with a content which a user watches.

(b) Director's Comments

Comments of a direction for a scene or scenes in a movie, comments of actors or actresses, memories in production of a movie, and notes can be received from internet, and displayed in a monitor in synchronization with a content which a user watches.

(c) Internet Shopping Data

A cloth which an actor or actress wears, and music played in a movie can be purchased through internet.

(d) Chat

A user can write his or her impressions to the content onto a notice board through internet. Other users can watch the impressions, and write his or her impressions to the notice board to have a chat with the first user.

(e) Streaming Data

A user can receive moving-picture streaming data having a few Mbps, through internet in synchronization with a content, and display the received moving-picture streaming data together with the content. For instance, a moving-picture streaming data includes a preview of a movie, and images of commercial messages. A user can record the received moving-picture streaming data into the SR_PRIVT. DAT file, and reproduce the data at any time.

Another example of data arrangement to the SR_PRIVT. DAT file is explained hereinbelow.

A weather report and news including traffic news, sports news and information on a price of stock are arranged in the SR_PRIVT. DAT file. These traffic news, sports news, stock-price information and other news, and a weather report are necessary to be latest, and in many cases, old news are unnecessary, if latest news are provided.

Hence, latest data or news is recorded as soon as new data or news is obtained through digital broadcasting, for instance, and old data or news is manually or automatically removed. For instance, if traffic jam news at twelve o'clock are received and recorded, traffic jam news at eight o'clock is automatically removed.

If data is recorded into the stream data file SR_TRANS. SRO or data recorded in the stream data file SR_TRANS. SRO is updated, partial removal of data has to be carried out frequently, resulting in instable operation of the DVD-SR recorder 101 and inefficient use of the disc 109.

By recording data into the SR_PRIVT. DAT file, it would be possible to efficiently update data, because a data-recording area is defined in the SR_PRIVT. DAT file, and in addition, it would be possible to automatically reproduce latest news including traffic news, sport news and stock-price information, for instance, a weather report, and so on.

Another example of data arrangement to the SR_PRIVT. DAT file is explained hereinbelow.

There are arranged a program number in which a resume marker is set, a program chain number, a cell number, a point (a time at which data is to be displayed), date and time at which the resume marker was made, a sector address, and character data associated with them, in the SR_PRIVT. DAT file.

A resume marker is used for storing a point at which data reproduction ended, when data reproduction out of the disc 109 is terminated. When data reproduction is restarted, data reproduction automatically starts at the point. In brief, a resume marker constitutes data for reproducing data in such a manner as VTR.

Resume marker data such as a program number in which a resume marker is set, a program chain number, a cell number, a point (a time at which data is to be displayed), date and time at which the resume marker was made, a sector address, and character data associated with them is defined in accordance with a DVD-VR format. However, since resume marker data is not defined in accordance with a DVD-SR format, resume marker data is recorded into the SR_PRIVT. DAT file.

Another example of data arrangement to the SR_PRIVT. DAT file is explained hereinbelow.

There are arranged a program number of typical image among a data file recorded in a recording medium such as a disc, a cell number, a point (a time at which data is to be displayed), date and time at which the typical image was made, a sector address, and character data associated with them, in the SR_PRIVT. DAT file.

As typical image, a scene which is most impressive to a user in a move, for instance, is recorded to the SR_PRIVT. DAT file. At a glance of the scene, the movie having the scene occurs to the user.

Data relating to the typical image, such as a program number of typical image among a data file recorded in a recording medium such as a disc, a cell number, a point (a time at which data is to be displayed), date and time at which the typical image was made, a sector address, and character data associated with them is defined in accordance with a DVD-Video or DVD-VR format, but not defined in accordance with a DVD-SR format. Hence, such data is arranged in the SR_PRIVT. DAT file.

Another example of data arrangement to the SR_PRIVT. DAT file is explained hereinbelow.

Video attribute data, audio attribute data and sub-picture attribute data are arranged in the SR_PRIVT. DAT file.

Video attribute data includes the following data, for instance.

(a) Compression type:

MPEG-1/MPEG-2/MPEG-4 and so on

(b) Number of scanning lines per a frame: 525/625

(c) Aspect ratio: 4:3/16:9

(d) whether user_data (-) is recorded at the first field, the twenty-first line

(e) whether user_data (-) is recorded at the second field, the twenty-first line

(f) Number of effective pixels per a line×Number of effective lines per a frame:

720×480/704×480/352×480/352×240/544×480/480×480 (in 525/60 system)

720×576/704×576/352×576/352×288/544×576/480×576 (in 625/50 system)

(g) Number of audio stream

(h) Number of sub-picture stream

(i) Analog copy protection type:

No analog copy protection/Type 1/Type 2/Type 3

(j) Seamless flag:

Indication of seamless/Indication of non-seamless

Audio attribute data includes the following data, for instance.

(a) Encoding mode:

Dolby AC-3/MPEG-1 or MPEG-2 (without extended stream)/MPEG-2 (with extended stream)/Linear PCM audio

(b) Quantization/DRC:

No data for Dolby AC-3

with or without DRC (Dynamic Range Control) for MPEG

Number of quantized bits=16/others for Linear PCM

(c) Sampling frequency: 48 kHz/44.1 kHz/32 kHz/others

(d) Number of audio channels:

1 ch (monophonic), 2 ch (stereo), 3 ch, 4 ch, 5 ch, 6 ch, 7 ch, 8 ch, 2 ch (dual monophonic), others

(e) Application flag:

Having audio data in the number of channels indicated as “audio channel number”/Having a plurality of channel modes comprised of monophonic, stereo and dual monophonic, and showing only typical mode of the present audio stream in “audio channel number”

(f) Bit rate:

64/80/96/112/128/160/192/224/256/320/384/448 kbps (AC-3)

64/80/96/112/128/160/192/224/256/320/384 kbps (MPEG-1, MPEG-2)

768/1536 kbps (LPCM)

(g) Original or dummy ?:

original audio data/dummy data to ensure space for future recording

(h) Analog copy protection type:

No analog copy protection/Type 1/Type 2/Type 3

(i) Seamless flag:

Reproduction in seamless/reproduction in non-seamless

(j) Audio gap:

Present or absent

Sub-picture attribute data includes the following data, for instance.

(a) A plurality of sets of brightness signals and color data of color signals

Another example of data arrangement to the SR_PRIVT. DAT file is explained hereinbelow.

Following data may be arranged in the SR_PRIVT. DAT file for retrieving video data.

(a) Thumbnail data:

Bit map data, thumbnail still image data defined by I picture in MPEG-2

(b) Sector address to jump into when each of thumbnails is selected:

Sector address to jump into when each of thumbnails is selected

(c) Header address of picture data stored as thumbnail data existing in a stream:

Header address of a thumbnail image plane in the assumption that an image plane in a stream is defined as a thumbnail image plane

(d) Character data associated with the thumbnail data:

Character data

Following data may be arranged in the SR_PRIVT. DAT file for retrieving audio data.

(a) Frame number of a header audio frame in each of retrieval, and a sector address in which header data of the header audio frame is recorded

(b) Character data associated with the header data

Data in data broadcasting may be arranged in the SR_PRIVT. DAT file as it is. Data in audio broadcasting may be arranged in the SR_PRIVT. DAT file as it is.

Hereinbelow is explained an example for producing, based on a map (mapping list) which describes a period of time for each of SOBUs having a fixed capacity of 64 kB and which is defined in accordance with a DVD-SR format, a map (VOBU entry) which describes a capacity and a time for each of VOBUs having a non-fixed capacity determined by a unit of compression, and which is defined in accordance with a DVD-VR format, a top VOBU number for each of predetermined period of time (TMU) starting from a head of VOB (Video Object), a VOBU address, and a map (time entry) describing a difference in time between TMU boundary and VOBU boundary, and recording the thus produced data into a memory.

There is further explained an example for producing a time map in which a time interval in map entry, a sector address of a top VOBU in the map entry, and a first sector addresses in all VOBUs are recorded, and which is defined in accordance with a DVD-Video format, and recording the thus produced data into a memory.

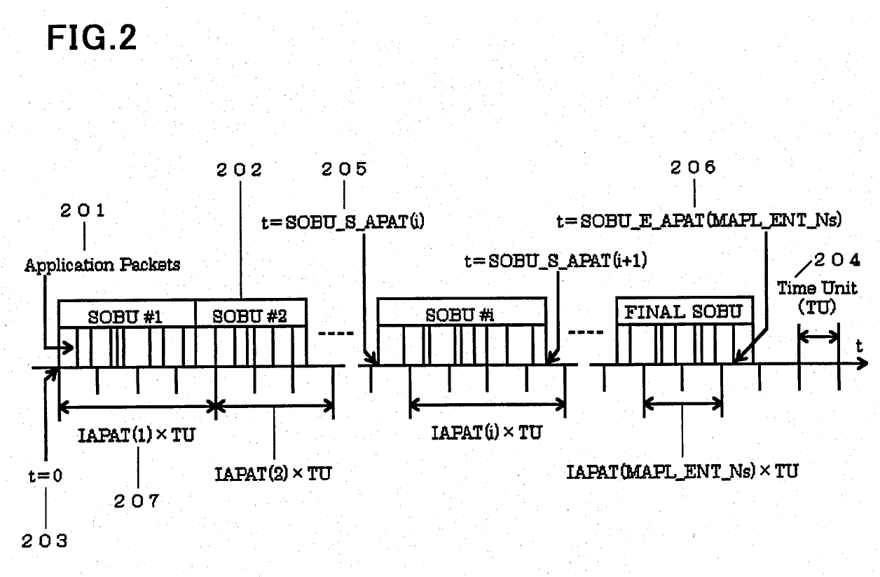

FIG. 2 illustrates a mapping list in a DVD-SR format.

The illustrated mapping list includes an application packet 201 and SOBUs 202.

A SOBU-starting application packet arrives at time 205 (SOBU_S_APAT), and a SOBU-ending application packet arrives at time 206 (SOBU_E_APAT). An incremental application packet arrives at time 207 IAPAT (Incremental Packet Arrival Time).

The total number of SOBUs in the disc is expressed as MAPL_ENT_Ns. Each of SOBUs 202 means a data block having a fixed capacity of 64 kB. A time unit (TU) 204 is defined as 5.69 msec, because a clock has a frequency of 90 kHz and 512 interval (512/90=5.69).

Time IAPAT 207 indicates the number of time units (TU) 204 between a first time unit after each of SOBUs starts and a first time unit after each of SOBUs ends. In accordance with a DVD-SR format, time IAPAT 207 for all of recorded SOBUs (IAPAT (1) to (IAPAT (MAPL_ENT_Ns)) is calculated, and recorded as table data. This is called a mapping list.

The mapping list records therein the time data IAPAT 207 for each of SOBUs 202 having a capacity of 64 kB. Hence, time search can be accomplished by subtracting the present time from a target time to thereby calculate an offset time, subtracting a time calculated for each of SOBUs, based on the time data IAPAT 207, from the offset time, and jumping to SOBU having zero (0) time as a result of the subtraction.

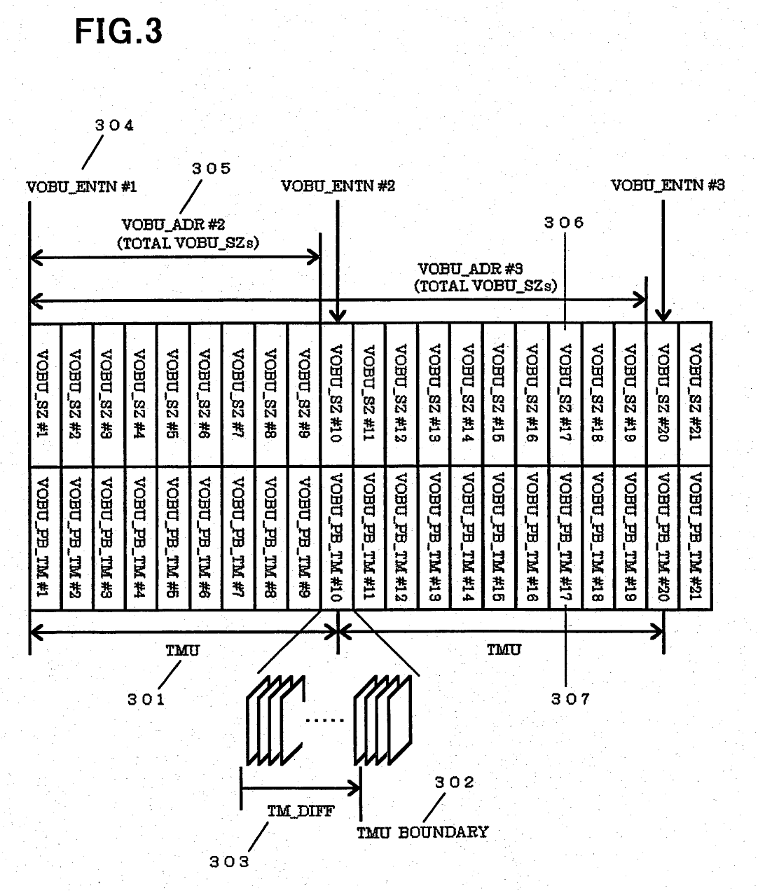

FIG. 3 illustrates a map in a DVD-VR format.

The map shows TMU 301, a TMU boundary 302, TM_DIFF 303, VOBU_ENTN 304, VOBU_ADR 305, VOBU_SZ 306, and VOBU_PB_TM 307.

In the map, VOBU indicates a data block having a capacity determined by an apparatus, and is usually comprised of GOP (Group Of Picture) defined in accordance with MPEG. However, VOBU is not always comprised of GOP. GOP is comprised usually of fifteen (15) pictures, but sometimes comprised of pictures other than fifteen.

With reference to FIG. 3, TMU 301 indicates a fixed period of time determined by an apparatus. For instance, TMU 301 is determined as ten (10) seconds.

TM_DIFF 303 indicates a time difference between TMU boundary 302 and a boundary of a final VOBU located just before TMU boundary 302.

VOBU_ENTN #k 304 indicates a number of a header VOBU of k-th TMU.

VOBU_ADR #k 305 indicates a sector address of a header VOBU of k-th TMU.

VOBU_SZ #k 306 indicates a number of sectors of k-th VOBU.

VOBU_PB_TM #k 307 indicates a time at which k-th VOBU is reproduced or recorded.

In accordance with a DVD-VR format, TM_DIFF 303 for all of TMUs 301, VOBU_ENTN #k 304, VOBU_ADR #k 305, VOBU_SZ #k 306 for all of recorded VOBUs, and VOBU_PB_TM #k 307 are calculated, and recorded as table data.

Time search is carried out through the use of the map as follows.

First, an offset time is calculated by subtracting the present time from a target time. Then, the offset time is divided by TMU 301, in which case, the figures below a decimal point are omitted. Using the quotient K, a VOBU number of a target TMU is obtained by virtue of VOBU_ENTN #k 304, and a header address of VOBU is obtained by virtue of VOBU_ADR #k 305. Then, a time defined in accordance with the formula X is determined as an initial value for the remainder of search time, and the header address of VOBU is determined as an initial value of an address to jump into.

X=offset time−(10 sec×K−TM_DIFF)

Further, searching in TMU is carried out as follows.

VOBU_PB_TM #k 307 is subtracted from the remainder of search time for each of VOBUs, and VOBU_SZ #k 306 is added to the address to jump into. The subtraction and addition is continued, until time is up. A resultant address to jump into is determined as a final address to jump into.

A map is made for a DVD-Video format.

Though not illustrated, in the navigation data file, a time interval of video time entry in the map, and a sector address of a header VOBU of video time entry are described in VTS_TMAPT (Video Title Set Time Map Table), and starting-sector addresses of all VOBUs are described in VTS_VOBU_ADMAP (Video Title Set Video Object Unit Address Map).

Time search is carried out through the use of the map as follows.

First, an offset time is calculated by subtracting the present time from a target time. Thus, an initial value of the remainder of search time and an initial value of a VOBU sector address both at a starting point of time entry closest to and before the target time are obtained by virtue of VTS_TMAPT. Then, VOBU time (0.5 seconds) is subtracted from the remainder of search time for each of VOBUs by virtue of VTS_VOBU_ADMAP, to thereby detect a VOBU sector address. The subtraction is continued until the remainder of search time becomes zero (0). A sector address resulted from VTS_VOB_ADMAP is determined as a final VOBU sector address to jump into.

Data necessary for carrying out such format conversion as mentioned above is extracted, and the thus extracted data is arranged in the SR_PRIVT. DAT file.

Data to be arranged in the SR_PRIVT. DAT file may be IAPAT data of a mapping list having a DVD-SR format. Specifically, the number of SOBUs 202, and IAPAT 207 both illustrated in FIG. 2 may be arranged in the SR_PRIVT. DAT file, in which case, it would be necessary for a DVD-VR or DVD-Video recorder receiving the data to convert a format of the received data.

As an alternative, data to be arranged in the SR_PRIVT. DAT file may be data from which data having a DVD-VR format could be readily produced, data from which data having a DVD-Video format could be readily produced, or data from which data having DVD-VR and DVD-Video formats could be readily produced.

Hereinbelow is explained an example of converting DVD-SR to DVD-VR.

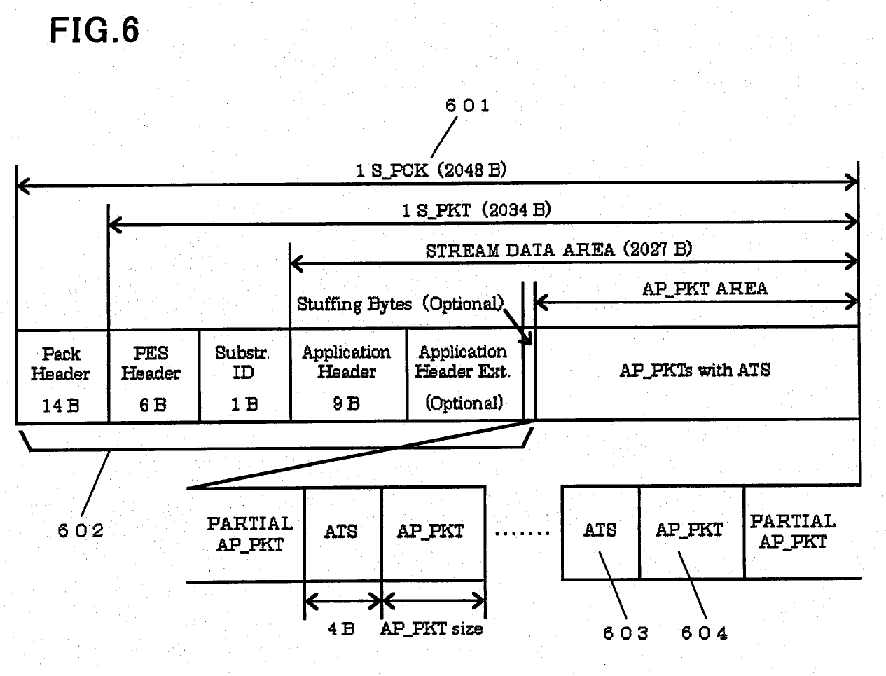

FIG. 6 illustrates a stream pack defined in accordance with a DVD-SR format.

As illustrated in FIG. 6, a stream pack S_PCK 601 having 2048 bytes is comprised of a stream pack header 602, an application time stamp ATS 603, and an application packet AP_PKT 604.

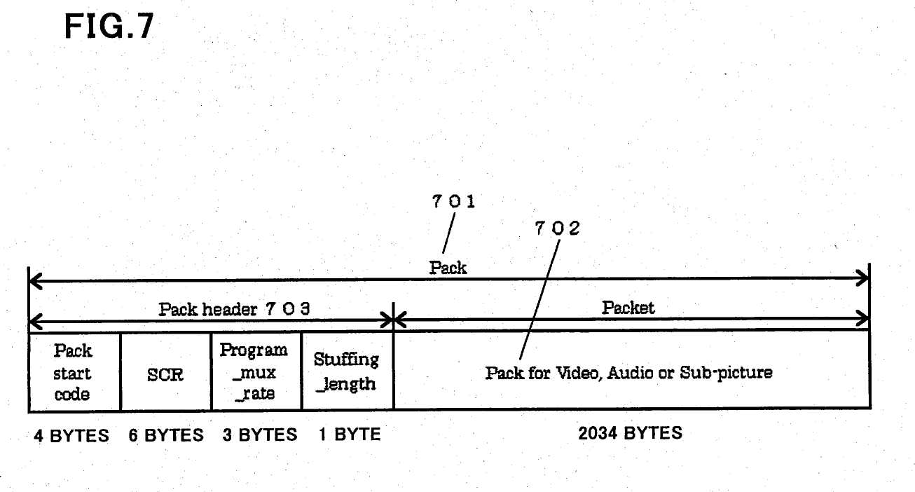

FIG. 7 illustrates a video pack defined in accordance with DVD-VR and DVD-Video forms.

As illustrated in FIG. 7, a video pack 701 having 2048 bytes is comprised of a pack header 703 and a pack 702 for video, audio or sub-picture.

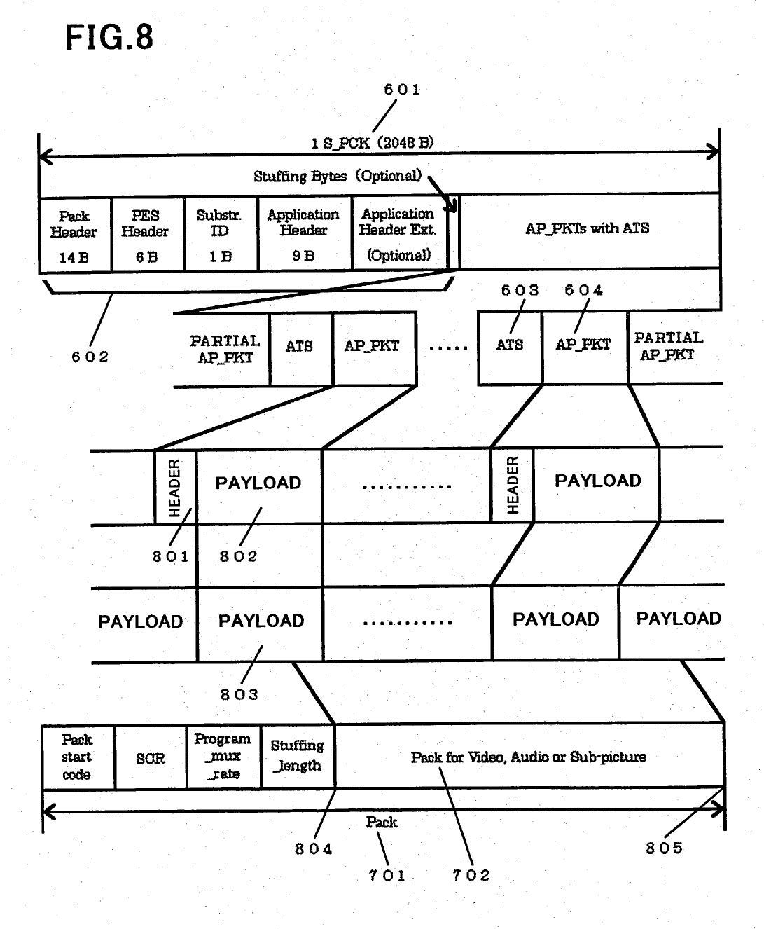

FIG. 8 illustrates an example in which the video pack illustrated in FIG. 7 is produced based on the stream pack illustrated in FIG. 6.

In FIG. 8, a header 801, a payload 802, a payload 803, a point 804 at which a video pack starts, and a point 805 at which a video pack ends are shown.

Hereinbelow is explained an example of producing pack data and additional data used for searching data, both defined in accordance with a DVD-VR format.

First, the application packet 604 is extracted out of the stream pack 601. The application packet 604 is comprised of the header 801 and the payload 802, as illustrated in FIG. 8.

Then, only a payload 803 is extracted out of the application packet 604.

Then, the video pack 701 is produced with the payload data 803 being turned into the video and audio data 702 in the video pack 701.

A header of GOP is extracted out of the payload data 803, and is arranged at the point 804 as a header of VOBU. An end of GOP is aligned to the point 805 as an end of VOBU by inserting stuffing into the pack 701. Thus, GOP is aligned to the pack 701.

Based on a mapping list indicating IAPAT 207 for all of SOBUs 201 having a DVD-SR format, there is produced a map (VOBU entry) describing the capacity VOBU_SZ #k 306 for each of VOBUs having a DVD-VR format, and the time VOBU_PB_TM #k 307.

TMU 301 is determined as 10 seconds, for instance. A map (time entry) describing a top VOBU's number VOBU_ENTN #k 304 and a top VOBU's address VOBU_ADR #k 305 is produced for each of TMUs from a header of VOB (Video OBject). For each of TMUs, there is produced TM_DIFF 303 indicating a difference between a head of TMU and a head of VOBU located just before the TMU.

VOBU entry data 306 and 307 and time entry data 301, 303, 304 and 305 are recorded into the private data file.

Data of the video pack 701 comprised of the stream pack 601 may be recorded into the private data file, or may not recorded into any file. Only additional data may be recorded into the private data file such that the data of the video pack 701 comprised of the stream pack 601 is recorded in a DVD-VR recorder. The stream pack header data 602, the application time stamp data 603 and the application packet header data 801 may be recorded into the private data file so as to make it possible to record data having been recorded in a DVD-VR recorder, into a DVD-SR recorder.

Whereas it is necessary to carry out calculation every 5.69 msec in a DVD-SR format, it is possible to carry out calculation in two stages in a DVD-VR format wherein rough calculation is carried out every 10 seconds in a first stage, and then, detailed calculation is carried out every 0.5 seconds in a second stage. Accordingly, production of data used for searching and having a DVD-VR format would make it ready to convert a format of the data into a DVD-VR format, and make it possible for a DVD-SR recorder to search at a higher rate even in a DVD-SR recorder.

Hereinbelow is explained an example of producing pack data and additional data used for search, both defined in accordance with a DVD-Video format.

In accordance with the above-mentioned method, the video pack 701 is produced based on the stream pack 601.

A mapping list indicating IAPAT 207 for all of SOBUs 201 having a DVD-SR format is converted into a time interval of video time entry in a map, a sector address of a header VOBU of the video time entry both in VTS_TMAPT (Video Title Set Time Map Table) having a DVD-Video format, and starting sector addresses of all VOBUs in VTS_VOBU_ADMAP (Video Title Set Video Object Unit Access Map).

Then, VTS_TMAPT data and VTS_VOBU_ADMAP data are recorded into the private data file.

Data of the video pack 701 comprised of the stream pack 601 may be recorded into the private data file, or may not recorded into any file. Only additional data may be recorded into the private data file such that the data of the video pack 701 comprised of the stream pack 601 is recorded in a DVD-VR recorder. The stream pack header data 602, the application time stamp data 603 and the application packet header data 801 may be recorded into the private data file so as to make it possible to record data having been recorded in a DVD-Video recorder, into a DVD-SR recorder.

Hereinbelow is explained an example in which, based on both an access unit start map (AUSM) describing whether there is a starting point of an access unit in each of SOBUs as a starting point of GOP, and an access unit end map (AUEM), there is produced a map (VOBU entry) describing a size of the first reference picture (1STREF_SZ) for each of VOBUs having a non-fixed capacity which is determined in dependence on a compression unit, and defined in accordance with a DVD-VR format, a capacity and a time.

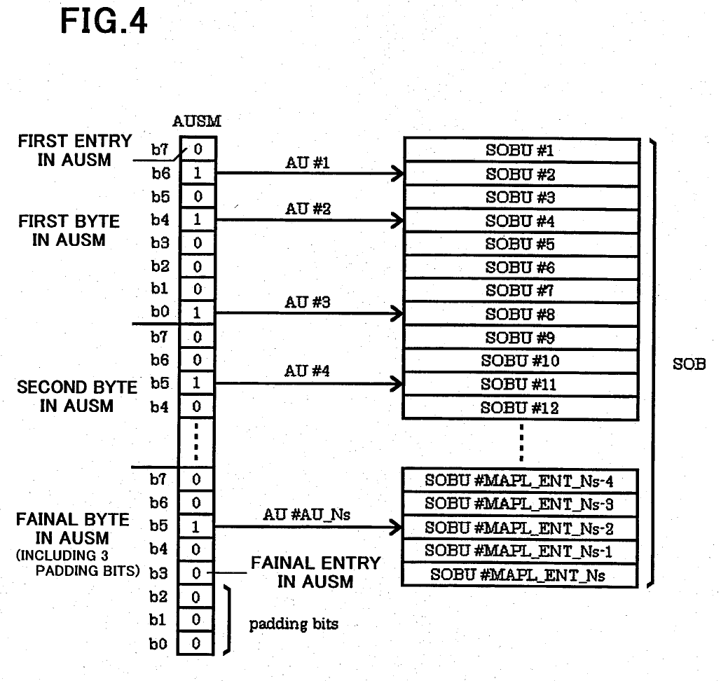

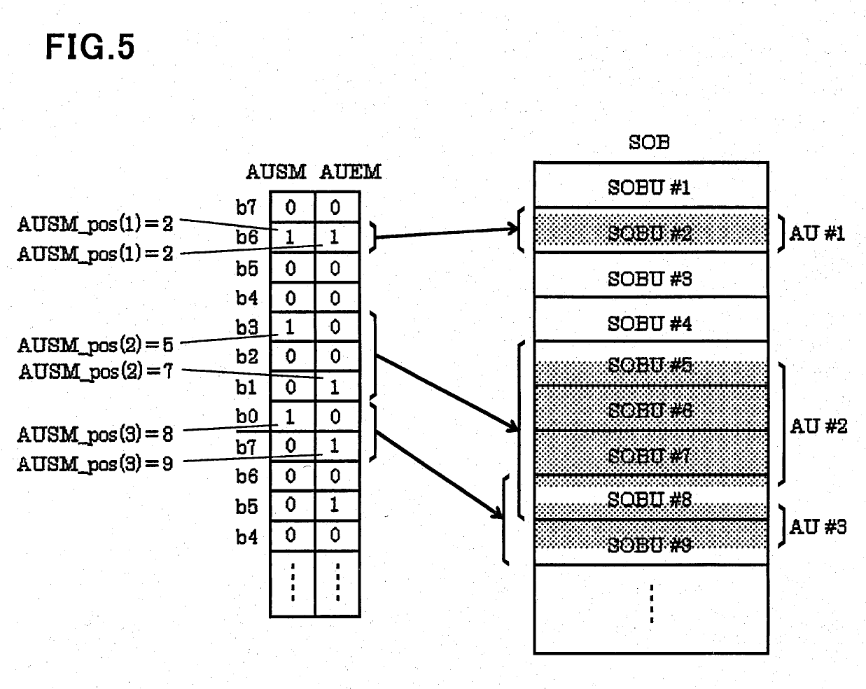

FIGS. 4 and 5 illustrates AUSM and AUEM. In FIG. 5, AUSM_pos(i) indicates a bit position at which i-th AU (Access Unit; I picture) starts in AUSM, and AUEM_pos(i) indicates a bit position at which i-th AU ends in AUEM, wherein “i” is equal to or greater than one (1), but equal to or smaller than AU_Ns (1≦i≦AU_Ns). Accordingly, i-th AU starts at SOBU #AUSM_pos(i), and ends at SOBU #AUEM_pos(i).

In accordance with the method having been explained with reference to FIGS. 6, 7 and 8, GOP is produced based on VOBU. Then, AU is read out of AUSM and AUEM to thereby produce a map (VOBU entry) describing a size of the first reference picture 1STREF_SZ of VOBU defined in accordance with a DVD-VR format, a capacity (VOBU_SZ #k), and a time (VOBU_PB_TM #k). Herein, 1STREF_SZ indicates an I picture size, in other words, a sector size necessary for arranging an I picture.

The resultant NV_PCK data is recorded into the private data file.

AUSM and AUEM only indicate whether an access unit (AU) starting point and an access unit ending point exit in a certain SOBU. Accordingly, if there is a plurality of AU starting points, AUSM and AUEM cannot distinguish each of the AU starting points from one another. Specifically, for instance, it would not be possible to recognize a starting SOBU after 10 GOPs or 10 access units (AUs) merely by counting AUs.

In contrast, 1STREF_SZ, VOBU_SZ #k and VOBU_PB_TM #k each having a DVD-VR format would make it possible to accurately detect an access unit (AU) every 10 GOPs. Accordingly, by producing data which can be reproduced at a variable rate and which accords with DVD-VR, it would be readily possible to convert a format of the data to a format of DVD-VR, and further, it would be also possible to reproduce the data at a variable rate and search the data through the use of a DVD-SR recorder.

Hereinbelow is explained an example in which, based on both an access unit start map (AUSM) describing whether there is a starting point of an access unit in each of SOBUs as a starting point of GOP, and an access unit end map (AUEM), there are produced FWD_n and BWDI_n of an address data navigation pack (NVP_CK) defined in accordance with a DVD-Video format.

FWD_n indicates a header sector address of VOBU (GOP) located previously of n VOBUs, and BWDI_n indicates a header sector address of VOBU (GOP) located ahead of n VOBUs. Herein, since “n” is selected from 1, 2, 3, 4, 5, 6, 7, 8, 9, 10, 11, 12, 13, 14, 15, 20, 60, 120 and 240, it would be necessary to find VOBU sector addresses by about 240 GOPs at the greatest. This means that 120-seconds earlier VOBU sector address and 120-seconds later VOBU sector address have to be found.

In accordance with the method having been explained with reference to FIGS. 6, 7 and 8, GOP is produced based on VOBU. Then, SOBU having an access unit starting point is reproduced, based on AUSM and AUEM each having a DVD-SR format. The thus reproduced SOBU may include two or more access unit starting points. Hence, taking this into consideration, an access unit starting point is detected, and the thus detected access unit starting point is stored in a memory.

Then, starting points of past 240 GOPs and next 240 GOPs are detected, and the thus detected starting points are stored in the memory. Then, there is produced an address data navigation pack NV_PCK. The thus produced NV_PCK data is stored into the private data file.

Hereinbelow is explained an example where there is produced a cell defined in accordance with a DVD-VR format, based on a stream cell defined in accordance with a DVD-SR format.

In a DVD-SR format, there are described, as data of a stream cell, a time at which the stream cell starts, a time at which the stream cell ends, a flag indicating a normal state or a temporarily erasing state, the number of entry points, included in the stream cell, an entry point time, and the number of SOBs to which the stream cell refers.

In contrast, in a DVD-VR format, there are described, as data of a cell, a time at which a cell starts being displayed, a time at which a cell ends being displayed, the number of entry points, included in the cell, and an entry point time. These data are converted in a format from DVD-SR to DVD-VR, and then, recorded into the private data file having a DVD-SR format.

Hereinbelow is explained an example where there is produced a cell defined in accordance with a DVD-Video format, based on a stream cell defined in accordance with a DVD-SR format.

In a DVD-Video format, starting sector addresses and ending sector addresses of all cells are described in a video title set cell address table VTS_C_ADT. Accordingly, starting sector addresses and ending sector addresses in a DVD-Video format are produced, based on both a time at which a stream cell starts being displayed and a time at which a stream cell ends being displayed both in a DVD-SR format, and then, the thus produced starting sector addresses and ending sector addresses are recorded into the private data file having a DVD-SR format.

When the above-mentioned data is arranged into the private data file, the data may be arranged into the private data file (SR_PRIVT. DAT file) as follows, for instance.

Hereinbelow is explained an example in which data for DVD-VR is arranged into the private data file (SR_PRIVT. DAT file) having a DVD-SR format.

Time map information TMAPI for a DVD-VR format is arranged into the private data file (SR_PRIVT. DAT file).

(a) Time Map General Information (TMAP_GI)

TM_ENT_Ns (Number of Time Entries) 2 bytes

(b) Number of time entries in time map information

VOBU_ENT_Ns (Number of VOBU Entries) 2 bytes

(c) Number of VOBU entries in time map information

TM_OFS (Time Offset) 2 bytes

(d) Time offset in time map information (Number of video fields from the first VOBU starting point to a TMU boundary appearing first after the first VOBU starting point)

Smaller than TMU

For instance, it is assumed that a 525/60 system has 600 video fields, and a 625/50 system has 500 video fields.

(e) Address offset in time map information

Address offset indicates a total size of all of VOBUs ahead of the audio video file. The number of sectors is described.

Time Entry #1 (TM_ENT #1)-Time Entry #r (TM_ENT #r)

VOBU_ENTN (VOBU Entry number) 2 bytes for each of time entries

(f) VOBU number

TM_DIFF (Time Difference) 1 byte

(g) Difference between a time at which VOBU located at a head of time entry #j starts to be displayed and a time at which time entry #j starts, calculated as (TMU×(j−1)+TM_OFS) (Number of video fields)

VOBU_ADR (Target VOBU address) 4 bytes

(h) a total size of VOBUs located ahead of a target VOBU (Number of sectors) VOBU Entry #1 (VOBU_ENT #1)-VOBU Entry #q (VOBU_ENT #q)

1STREF_SZ (size of the first reference picture) 1 byte for each of VOBU entries

(i) Size of the first reference picture (I-picture) of VOBU (Number of sectors)

A size of the first reference picture is defined as a size lasting to a final address of a video pack including final data.

The final address is measures as a relative sector address starting from a first sector of the VOBU.

VOBU_PB_TM (Playback Time of this VOBU) 6 bits

(j) Time for reproducing VOBU (Number of video fields)

VOBU_SZ (Size of the VOBU) 10 bits

(k) Size of VOBU (Number of sectors)

Hereinbelow is explained an example of arrangement of data for DVD-Video.

Video Title Set Time Map Table (VTS_TMAPT) is arranged as follows.

(a) Video Title Set Time Map Table Information (VTS_TMAPT) 8 bytes

(a-1) VTS_TMAP_Ns (Total number of VTS_TMAPs) 2 bytes

(a-2) reserved 2 bytes

(a-3) VTS_TMAPT_EA (End Address of VTS_TMAPT) 4 bytes

(b) Video Title Set Time Map #1 Search Pointer (VTS_TMAP_SRP #1)-Video Title Set Time Map #n Search Pointer (VTS_TMAP_SRP #n) 4 bytes

(b-1) VTS_TMAPT_SA (Start Address of VTS_TMAPT) 4 bytes

(c) Video Title Set Time Map #1 (VTS_TMAP #1)-Video Title Set Time Map #n (VTS_TMAP #n)

(c-1) TMU (Time Unit second) 1 byte (Time interval between map entries)

(c-2) reserved 1 byte

(c-3) MAP EN_Ns (Number of Map Entries) 2 bytes

(c-4) MAP ENT (Table of Map Entry) 4 bytes×Map Entries (Sector addresses of header VOBUs in time units)

The following address data navigation pack (NV_PCK) is calculated and recorded for all of VOBUs.

(a) FWDI_{—}240, 120, 60, 20, 15, 14, 13, 12, 11, 10, 9, 8, 7, 6, 5, 4, 3, 2, 1 6 bytes (+n VOBU start address and Video exit flag) 4 bytes×19

FWDI_n indicates a VOBU address of a picture located 0.5n second later than this VOBU.

(b) BWDI_{—}1, 2, 3, 4, 5, 6, 7, 8, 9, 10, 11, 12, 13, 14, 15, 20, 60, 120, 240 (−n VOBU start address and Video exit flag) 4 bytes×19

BWDI_n indicates a VOBU address of a picture located 0.5n second earlier than this VOBU.

Hereinbelow is explained a structure of the private data file SR_PRIVT. DAT.

The private data file SR_PRIVT. DAT in the present invention may be comprised of the stream pack illustrated in FIG. 6, that is, a transport stream. As an alternative, the private data file SR_PRIVT. DAT in the present invention may be comprised of the video pack illustrated in FIG. 7, that is, a program stream. As an alternative, the private data file SR_PRIVT. DAT in the present invention may be comprised of PES or ES defined in accordance with a MPEG format, or comprised of formats other than MPEG. That is, the private data file SR_PRIVT. DAT in the present invention may have any structure.

Hereinbelow is explained a method of transferring such data as mentioned above.

When the image audio stream data file (SR_TRANS. SRO), the navigation data file (SR_MANGR. IFO) and the private data file (SR_PRIVT. DAT) are transferred to a digital recorder such as D-VHS, VTR, a DVD-VR recorder or a DVD-Video recorder from a DVD-SR recorder through a digital interface, those files are transferred as follows in the case that a transfer format is defined as IEEE 1394.

The image audio stream data, the navigation data and the private data are transferred in time-division through a common line. The image audio stream data file (SR_TRANS. SRO) is transferred in an isochronous mode, that is, a mode in which a minimum transfer rate is guaranteed. The navigation data file (SR_MANGR. IFO) and the private data file (SR_PRIVT. DAT) are transferred as additional data in an asynchronous mode, that is, a mode in which a minimum transfer rate is not guaranteed.

The image audio stream data file (SR_TRANS. SRO), the navigation data file (SR_MANGR. IFO) and the private data file (SR_PRIVT. DAT) are transferred to a DVD-SR recorder from a digital recorder through IEEE 1394 in the same way as mentioned above.

When the image audio stream data file (SR_TRANS. SRO), the navigation data file (SR_MANGR. IFO) and the private data file (SR_PRIVT. DAT) are transferred to a DVD recorder such as a DVD-VR recorder or a DVD-Video recorder, they may be transferred as follows.

The image audio stream data file (SR_TRANS. SRO), the navigation data file (SR_MANGR. IFO) and the private data file (SR_PRIVT. DAT) are transferred separately from one another, that is, through separate interfaces, in which case, interfaces may be different in type from one another. For instance, IEEE 1394 may be divided into two lines. This ensures that all data can be transferred within a limited period of time, even if the navigation data and the private data had a large capacity.

The image audio stream data file (SR_TRANS. SRO), the navigation data file (SR_MANGR. IFO) and the private data file (SR_PRIVT. DAT) may be transferred in the same way as mentioned above to DVD-SR recorder from a DVD recorder such as a DVD-VR recorder or a DVD-Video recorder.

When the image audio stream data file (SR_TRANS. SRO), the navigation data file (SR_MANGR. IFO) and the private data file (SR_PRIVT. DAT) are transferred to a DVD recorder such as a DVD-VR recorder and a DVD-Video recorder, the image audio stream data file may be transferred through a line, that is, through an interface, and the navigation data file and the private data may be transferred through another line, that is, through another interface with additional data being multiplexed into the navigation and private data files. The interfaces may be identical in type with one another. For instance, IEEE 1394 may be divided into two lines. This ensures that all data can be transferred within a limited period of time, even if the navigation data and the private data had a large capacity. In addition, it would be also possible to reduce the number of lines, ensuring reduction in costs, weight and power consumption.

The image audio stream data file (SR_TRANS. SRO), the navigation data file (SR_MANGR. IFO) and the private data file (SR_PRIVT. DAT) are transferred to a DVD-SR recorder from a DVD recorder in the same way as mentioned above.

A DVD-VR or DVD-Video recorder which received the above-mentioned image audio stream data file (SR_TRANS. SRO), navigation data file (SR_MANGR. IFO) and private data file (SR_PRIVT. DAT) from a DVD-SR recorder produces navigation data defined in accordance with a DVD-VR or DVD-Video format, based on the received navigation and private data, and then, records or reproduces data in accordance with a DVD-VR or DVD-Video format. Since reproduction of data is carried out in accordance with the format, high-quality functions such as retrieval, reproduction in a particular manner, and editing can be accomplished.

Among the received data, data which is not determined in each of the formats as to where it is recorded, such as ATS 603 illustrated in FIG. 6, may be recorded as private data in each of the formats, and be multiplexed to data to be reproduced and output to a digital interface. As an alternative, such data may be removed without being recorded.

A DVD-SR recorder which received the above-mentioned image audio stream data file (SR TRANS. SRO), navigation data file (SR_MANGR. IFO) and private data file (SR_PRIVT. DAT) from a DVD-VR or DVD-Video recorder produces navigation data defined in accordance with a DVD-SR format, based on the received navigation and private data, and then, records or reproduces data in accordance with a DVD-SR format. Since reproduction of data is carried out in accordance with the format, high-quality functions such as retrieval, reproduction in a particular manner, and editing can be accomplished.

Though the embodiment has been explained above by using a DVD-SR, DVD-VR or DVD-Video recorder as an example, a DVD-VR recorder, a DVD-Video recorder and a DVD-SR recorder may be replaced with a format for recording images, a format only for reproducing images, and a format for recording a stream all other than the formats having been mentioned so far, respectively, among formats defined in accordance with a DVD format.

Similarly, a DVD-VR recorder, a DVD-Video recorder and a DVD-SR recorder may be replaced with a format for recording images, a format only for reproducing images, and a format for recording a stream all other than the formats having been mentioned so far, respectively, among formats other than formats defined in accordance with a DVD format.

Herein, a format only for reproducing images indicates a format for recording image and audio data in an apparatus through which a user reproduces image and audio data recorded in an optical disc by a content provider.

A format for recording images indicates a format for recording image and audio data in an apparatus through which a user records image and audio data into an optical disc or a hard disc, and reproduces the recorded image and audio data.

A format for recording a stream indicates a format for recording an image and audio stream in an apparatus through which a user records an image and audio stream transmitted through digital broadcasting, into an optical disc or a hard disc, and reproduces the recorded image and audio data.

The DVD-SR, DVD-VR and DVD-Video formats having been referred to in the above-mentioned embodiment are explained in detail in “DVD Specifications for DVD-RAM/DVD-RW/DVD-R for General Discs, Part 5, Stream Recording”, “DVD Specifications for DVD-RAM/DVD-RW/DVD-R for General Discs, Part 3, Video Recording”, and “DVD Specifications for Read-Only Disc, Part 3, Video Specifications”, respectively.

Though data is recorded all into the private data file SR_PRIVT. DAT in the above-mentioned embodiment, data may be recorded into a private data recording area in the stream data file SR_TRANS. SRO, such as PES_private _data in PES Packet, or into a character data recording area in the stream data file SR_TRANS. SRO.

As an alternative, data may be recorded into a character data recording area in the navigation data file SR_MANGR. IFO, such as IT_TXT in TXDT_MG, or into a private data recording area in the navigation data file SR_MANGR. IFO.

The above-mentioned image audio stream data file (SR_TRANS. SRO), navigation data file (SR_MANGR. IFO) and private data file (SR_PRIVT. DAT) may be stored in a recording medium.

In the specification, the term “recording medium” means any medium which can record data therein.

The term “recording medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM such as a compact flush card, a hard disk, and any other suitable means for storing a program therein.

A hard disc equipped in a server may be employed as a recording medium.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Applications Nos. 2002-14194 and 2002-171521 filed on Jan. 23, 2002 and Jun. 23, 2002, respectively, each including specification, claims, drawings and summary is incorporated herein by reference in its entirety.

What is claimed is:

1. A method of recording image data, comprising the steps of:
(a) recording image audio stream data as one stream data file;
(b) recording navigation data as one navigation data file;
(c) recording private data as one or more private data file(s); and
(d) recording at least one of (d1) table data included in a stream and (d2) descriptor(s) included in said table data, into a first or second area in said private data file, said stream data file or said navigation data file,
wherein said first area is defined as an area into which character data is to be recorded, and said second area is defined as an area into which private data is to be recorded.

2. The method as set forth in claim 1, wherein said table data includes at least one of PSI (Program Specific Information) data defined by MPEG (Moving Picture Expert Group) and table data indicative of program arrangement produced by ARIB (Association of Radio Industries and Business) as standard for digital-broadcasting, and
said descriptor(s) includes a descriptor or descriptors defined by MPEG and a descriptor or descriptors produced by ARIB as standard for digital-broadcasting.

3. The method as set forth in claim 1, wherein said table data includes at least one of extended table data produced by ARIB as standard for digital-broadcasting and table data other than able data indicative of program arrangement produced by ARIB as standard for digital-broadcasting, and
said descriptor(s) includes a descriptor or descriptors included in said extended table data and a descriptor or descriptors included in said table data other than able data indicative of program arrangement produced by ARIB as standard for digital-broadcasting.

4. The method as set forth in claim 1, wherein said table data includes table data defined by DVB (Digital Video Broadcasting), and
said descriptor(s) includes a descriptor or descriptors included in table data defined by DVB.

5. The method as set forth in claim 1, wherein said table data includes table data defined by ATSC (Advanced Television System Committee), and
said descriptor(s) includes a descriptor or descriptors included in table data defined by ATSC.

6. The method as set forth in claim 1, wherein said stream data file is defined as SR_TRANS. SRO defined by DVD-SR format, said navigation data file is defined as SR_MANGR. IFO defined by DVD-SR format, and said private data file is defined as SR_PRIVT. DAT defined by DVD-SR format.

7. A method of recording image data, comprising the steps of
(a) recording image audio stream data as one stream data file;
(b) recording navigation data as one navigation data file;
(c) recording private data as one or more private data file(s); and
(d) recording at least one of video attribute data, audio attribute data and sub-picture attribute data into a first or second area in said private data file, said stream data file or said navigation data file,
wherein said first area is defined as an area into which character data is to be recorded, and said second area is defined as an area into which private data is to be recorded.

8. The method as set forth in claim 7, wherein said video attribute data includes at least one of (a) a method of compressing data, (b) the number of scanning lines per a frame, (c) an aspect ratio, (d) status of recording user data into the first field, the twenty-first line, (e) status of recording user data into the second field, the twenty-first line, (f) the number of effective pixels per a line and the number of effective lines per a frame, (g) the number of audio stream, and (h) the number of sub-picture stream.

9. The method as set forth in claim 7, wherein said audio attribute data includes at least one of (a) encoding mode, (b) the number of quantized bits, (c) whether dynamic range control is carried out or not, (d) a sampling frequency, (e) the number of audio channels, (f) an application flag, (g) a bit rate, (h) indication as to whether said audio attribute data is original or dummy, (i) an analog copy protection type, (j) a seamless flag, and (k) whether there is audio gap or not.

10. The method as set forth in claim 7, wherein said sub-picture attribute data includes color data of a brightness signal and a color signal.

11. The method as set forth in claim 7, wherein said stream data file is defined as SR_TRANS. SRO defined by a DVD-SR format, said navigation data file is defined as SR_MANGR. IFO defined by a DVD-SR format, and said private data file is defined as SR_PRIVT. DAT defined by a DVD-SR format.

12. A method of recording image data, comprising the steps of
(a) recording image audio stream data as one stream data file;
(b) recording navigation data as one navigation data file;
(c) recording private data as one or more private data file(s); and
(d) recording (d1-a) thumbnail data; and an address to jump into when said thumbnail address is selected, or (d1-b) a header address of picture data recorded as thumbnail data existing in a stream, and (d2) character data associated with said thumbnail data, said address and said header address, into a first or second area in said private data file, said stream data file or said navigation data file for retrieving video data,
wherein said first area is defined as an area into which character data is to be recorded, and said second area is defined as an area into which private data is to be recorded.

13. The method as set forth in claim 12, wherein a frame number of a header audio frame in each of retrieval, an address in which header audio frame data is recorded, and character data associated with said frame number and said address are recorded in said first or second area for retrieving audio data.

14. The method as set forth in claim 12, wherein said stream data file is defined as SR_TRANS. SRO defined by DVD-SR format, said navigation data file is defined as SR_MANGR. IFO defined by DVD-SR format, and said private data file is defined as SR_PRIVT. DAT defined by DVD-SR format.

15. A method of recording image data, comprising the steps of:
(a) recording image audio stream data as one stream data file;
(b) recording navigation data as one navigation data file;
(c) recording private data as one or more private data file(s); and
(d) recording at least one of data broadcasting and audio broadcasting into a first or second area in said private data file, said stream data file or said navigation data file,
wherein said first area is defined as an area into which character data is to be recorded, and said second area is defined as an area into which private data is to be recorded.

16. The method as set forth in claim 15, wherein said stream data file is defined as SR_TRANS. SRO defined by DVD-SR format, said navigation data file is defined as SR_MANGR. IFO defined by DVD-SR format, and said private data file is defined as SR_PRIVT. DAT defined by DVD-SR format.

17. A method of recording image data, comprising the steps of:
(a) recording image audio stream data as one stream data file;
(b) recording navigation data as one navigation data file;
(c) recording private data as one or more private data file(s);
(d) converting search data recorded in said navigation data file in a stream-recording format into search data in an image-recording format or in a format only for reproducing image data; and
(e) recording said search data resulted from said step (d) into a first or second area in said private data file, said stream data file or said navigation data file,
wherein said first area is defined as an area into which character data is to be recorded, and said second area is defined as an area into which private data is to be recorded.

18. The method as set forth in claim 17, further comprising the steps of:
converting data used for reproducing data at a variable rate and recorded in said navigation data file in a stream-recording format is into data used for reproducing data at a variable rate, in an image-recording format or in a format only for reproducing image data; and
recording the thus converted data into said first or second area.

19. The method as set forth in claim 17, further comprising the steps of:
converting cell data used for editing data and recorded in said navigation data file in a stream-recording format converted into cell data used for editing data, in an image-recording format or in a format only for reproducing image data; and
recording the thus converted data into said first or second area.

20. The method as set forth in claim 17, further comprising the steps of
(f) extracting search data, data used for reproducing data at a variable rate and cell data used for editing data, out of data having an image-recording format or a format only for reproducing image data;
(g) recording the thus extracted data into said first or second area;
(h) converting image audio data having an image-recording format or a format only for reproducing image data, into image-audio data having a stream-recording format; and
(i) recording image audio stream and navigation data as a stream data file and a navigation data file, respectively,
said steps (g) and (i) being to be concurrently carried out.

21. The method as set forth in claim 17, wherein said stream data file is defined as SR_TRANS. SRO defined by DVD-SR format, said navigation data file is defined as SR_MANGR. IFO defined by DVD-SR format, and said private data file is defined as SR_PRIVT. DAT defined by DVD-SR format.

22. A method of recording image data, comprising the steps of:
(a) recording image audio stream data as one stream data file;
(b) recording navigation data as one navigation data file;
(c) recording private data as one or more private data file(s); and
(d) recording at least a part of internet data, director's cut, director's comment data, internet shopping data, chat data, and streaming data all associated with a data file recorded in accordance with the present method, into a first or second area,
wherein said first area is defined as an area into which character data is to be recorded, and said second area is defined as an area into which private data is to be recorded.

23. The method as set forth in claim 22, wherein said stream data file is defined as SR_TRANS. SRO defined by DVD-SR format, said navigation data file is defined as SR_MANGR. IFO defined by DVD-SR format, and said private data file is defined as SR_PRIVT. DAT defined by DVD-SR format.

24. A method of recording image data, comprising the steps of:
(a) recording image audio stream data as one stream data file;
(b) recording navigation data as one navigation data file;
(c) recording private data as one or more private data file(s); and
(d) recording at least a part of news including traffic, sport and a stock price, and a weather forecast into a first or second area,
wherein said first area is defined as an area into which character data is to be recorded, and said second area is defined as an area into which private data is to be recorded.

25. The method as set forth in claim 24, further comprising the step of manually or automatically updating said news and said weather forecast.

26. The method as set forth in claim 24, wherein said stream data file is defined as SR_TRANS. SRO defined by DVD-SR format, said navigation data file is defined as SR MANGR. IFO defined by DVD-SR format, and said private data file is defined as SR_PRIVT. DAT defined by DVD-SR format.

27. A method of recording image data, comprising the steps of
(a) recording image audio stream data as one stream data file;
(b) recording navigation data as one navigation data file;
(c) recording private data as one or more private data file(s); and
(d) recording at least a part of a program number in which a resume marker is set, a program chain number, a cell number, a point, date and time at which a marker was fabricated, a sector address, and character data associated with those into a first or second area,
wherein said first area is defined as an area into which character data is to be recorded, and said second area is defined as an area into which private data is to be recorded.

28. The method as set forth in claim 27, wherein said stream data file is defined as SR_TRANS. SRO defined by DVD-SR format, said navigation data file is defined as SR_MANGR. IFO defined by DVD-SR format, and said private data file is defined as SR_PRIVT. DAT defined by DVD-SR format.

29. A method of recording image data, comprising the steps of:
(a) recording image audio stream data as one stream data file;
(b) recording navigation data as one navigation data file;
(c) recording private data as one or more private data file(s); and
(d) recording at least a part of a program number of typical image of a data file recorded in accordance with the present method, a cell number, a point, date and time at which said typical image was produced, a sector address, and character data associated with those into a first or second area,
wherein said first area is defined as an area into which character data is to be recorded, and said second area is defined as an area into which private data is to be recorded.

30. The method as set forth in claim 29, wherein said stream data file is defined as SR_TRANS. SRO defined by DVD-SR (Stream Recording) format, said navigation data file is defined as SR_MANGR. IFO defined by DVD-SR format, and said private data file is defined as SR_PRIVT. DAT defined by DVD-SR format.

31. A method of transferring image data, wherein when at least one of an image audio stream data file, a navigation data file and a private data file all recorded in accordance with the method defined in claim 1 is(are) transferred through a common interface, said image audio stream data file is transferred in a mode in which a minimum transfer rate is guaranteed, and said navigation data file and said private data file are transferred in a mode in which a minimum transfer rate is not guaranteed.

32. A method of transferring image data, wherein when at least one of an image audio stream data file, a navigation data file and a private data file all recorded in accordance with the method defined in claim 7 is(are) transferred through a common interface, said image audio stream data file is transferred in a mode in which a minimum transfer rate is guaranteed, and said navigation data file and said private data file are transferred in a mode in which a minimum transfer rate is not guaranteed.

33. A method of transferring image data, wherein when at least one of an image audio stream data file, a navigation data file and a private data file all recorded in accordance with the method defined in claim 12 is(are) transferred through a common interface, said image audio stream data file is transferred in a mode in which a minimum transfer rate is guaranteed, and said navigation data file and said private data file are transferred in a mode in which a minimum transfer rate is not guaranteed.

34. A method of transferring image data, wherein when at least one of an image audio stream data file, a navigation data file and a private data file all recorded in accordance with the method defined in claim 15 is(are) transferred through a common interface, said image audio stream data file is transferred in a mode in which a minimum transfer rate is guaranteed, and said navigation data file and said private data file are transferred in a mode in which a minimum transfer rate is not guaranteed.

35. A method of transferring image data, wherein when at least one of an image audio stream data file, a navigation data file and a private data file all recorded in accordance with the method defined in claim 17 is(are) transferred through a common interface, said image audio stream data file is transferred in a mode in which a minimum transfer rate is guaranteed, and said navigation data file and said private data file are transferred in a mode in which a minimum transfer rate is not guaranteed.

36. A method of transferring image data, wherein when at least one of an image audio stream data file, a navigation data file and a private data file all recorded in accordance with the method defined in claim 22 is(are) transferred through a common interface, said image audio stream data file is transferred in a mode in which a minimum transfer rate is guaranteed, and said navigation data file and said private data file are transferred in a mode in which a minimum transfer rate is not guaranteed.

37. A method of transferring image data, wherein when at least one of an image audio stream data file, a navigation data file and a private data file all recorded in accordance with the method defined in claim 24 is(are) transferred through a common interface, said image audio stream data file is transferred in a mode in which a minimum transfer rate is guaranteed, and said navigation data file and said private data file are transferred in a mode in which a minimum transfer rate is not guaranteed.

38. A method of transferring image data, wherein when at least one of an image audio stream data file, a navigation data file and a private data file all recorded in accordance with the method defined in claim 27 is(are) transferred through a common interface, said image audio stream data file is transferred in a mode in which a minimum transfer rate is guaranteed, and said navigation data file and said private data file are transferred in a mode in which a minimum transfer rate is not guaranteed.

39. A method of transferring image data, wherein when at least one of an image audio stream data file, a navigation data file and a private data file all recorded in accordance with the method defined in claim 29 is(are) transferred through a common interface, said image audio stream data file is transferred in a mode in which a minimum transfer rate is guaranteed, and said navigation data file and said private data file are transferred in a mode in which a minimum transfer rate is not guaranteed.

40. A method of transferring image data, wherein when an image audio stream data file, a navigation data file and a private data file all recorded in accordance with the method defined in claim 1 are transferred separately from one another.

41. A method of transferring image data, wherein when an image audio stream data file, a navigation data file and a private data file all recorded in accordance with the method defined in claim 7 are transferred separately from one another.

42. A method of transferring image data, wherein when an image audio stream data file, a navigation data file and a private data file all recorded in accordance with the method defined in claim 12 are transferred separately from one another.

43. A method of transferring image data, wherein when an image audio stream data file, a navigation data file and a private data file all recorded in accordance with the method defined in claim 15 are transferred separately from one another.

44. A method of transferring image data, wherein when an image audio stream data file, a navigation data file and a private data file all recorded in accordance with the method defined in claim 17 are transferred separately from one another.

45. A method of transferring image data, wherein when an image audio stream data file, a navigation data file and a private data file all recorded in accordance with the method defined in claim 22 are transferred separately from one another.

46. A method of transferring image data, wherein when an image audio stream data file, a navigation data file and a private data file all recorded in accordance with the method defined in claim 24 are transferred separately from one another.

47. A method of transferring image data, wherein when an image audio stream data file, a navigation data file and a private data file all recorded in accordance with the method defined in claim 27 are transferred separately from one another.

48. A method of transferring image data, wherein when an image audio stream data file, a navigation data file and a private data file all recorded in accordance with the method defined in claim 29 are transferred separately from one another.

49. A method of transferring image data, wherein when an image audio stream data file recorded in accordance with the method defined in claim 1 is transferred through a line, and data into which at least one of a navigation data file and a private data file both recorded in accordance with the method defined in claim 1 is(are) multiplexed transferred through another line.

50. A method of transferring image data, wherein when an image audio stream data file recorded in accordance with the method defined in claim 7 is transferred through a line, and data into which at least one of a navigation data file and a private data file both recorded in accordance with the method defined in claim 7 is(are) multiplexed transferred through another line.

51. A method of transferring image data, wherein when an image audio stream data file recorded in accordance with the method defined in claim 12 is transferred through a line, and data into which at least one of a navigation data file and a private data file both recorded in accordance with the method defined in claim 12 is(are) multiplexed transferred through another line.

52. A method of transferring image data, wherein when an image audio stream data file recorded in accordance with the method defined in claim 15 is transferred through a line, and data into which at least one of a navigation data file and a private data file both recorded in accordance with the method defined in claim 15 is(are) multiplexed transferred through another line.

53. A method of transferring image data, wherein when an image audio stream data file recorded in accordance with the method defined in claim 17 is transferred through a line, and data into which at least one of a navigation data file and a private data file both recorded in accordance with the method defined in claim 17 is(are) multiplexed transferred through another line.

54. A method of transferring image data, wherein when an image audio stream data file recorded in accordance with the method defined in claim 22 is transferred through a line, and data into which at least one of a navigation data file and a private data file both recorded in accordance with the method defined in claim 22 is(are) multiplexed transferred through another line.

55. A method of transferring image data, wherein when an image audio stream data file recorded in accordance with the method defined in claim 24 is transferred through a line, and data into which at least one of a navigation data file and a private data file both recorded in accordance with the method defined in claim 24 is(are) multiplexed transferred through another line.

56. A method of transferring image data, wherein when an image audio stream data file recorded in accordance with the method defined in claim 27 is transferred through a line, and data into which at least one of a navigation data file and a private data file both recorded in accordance with the method defined in claim 27 is(are) multiplexed transferred through another line.

57. A method of transferring image data, wherein when an image audio stream data file recorded in accordance with the method defined in claim 29 is transferred through a line, and data into which at least one of a navigation data file and a private data file both recorded in accordance with the method defined in claim 29 is(are) multiplexed transferred through another line.

58. A method of receiving and recording image data, comprising the steps of:
(a) receiving data having been transferred in accordance with the method defined in claim 31;
(b) converting a data file of the received data, having a stream-recording format, into a data file having an image-recording format or a data file having a format used only for reproducing image data; and
(c) recording the received data in the thus converted format.

59. A method of receiving and recording image data, comprising the steps of:
(a) receiving data having been transferred in accordance with the method defined in claim 40;
(b) converting a data file of the received data, having a stream-recording format, into a data file having an image-recording format or a data file having a format used only for reproducing image data; and
(c) recording the received data in the thus converted format.

60. A method of receiving and recording image data, comprising the steps of:
(a) receiving data having been transferred in accordance with the method defined in claim 49;
(b) converting a data file of the received data, having a stream-recording format, into a data file having an image-recording format or a data file having a format used only for reproducing image data; and
(c) recording the received data in the thus converted format.

61. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 1.

62. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 7.

63. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 12.

64. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 15.

65. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 17.

66. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 22.

67. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 24.

68. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 27.

69. A method of receiving and recording image data, comprising the steps of:
(a) receiving a data file having an image-recording format or a format used only for reproducing image data;
(b) converting the thus received data file into a data file having a stream-recording format; and
(c) recording the thus converted data file in accordance with the method defined in claim 29.

70. The method as set forth in claim 58, wherein said stream-recording format is DVD-SR (Stream Recording), said image-recording format is DVD-VR (Video Recording), and said form used only for reproducing image is DVD-Video format.

71. The method as set forth in claim 61, wherein said stream-recording format is DVD-SR (Stream Recording), said image-recording format is DVD-VR (Video Recording), and said form used only for reproducing image is DVD-Video format.

72. A recorder for recording at least one of image audio stream data, navigation data and private data therein in accordance with the method defined in claim 1.

73. A recorder for recording at least one of image audio stream data, navigation data and private data therein in accordance with the method defined in claim 7.

74. A recorder for recording at least one of image audio stream data, navigation data and private data therein in accordance with the method defined in claim 12.

75. A recorder for recording at least one of image audio stream data, navigation data and private data therein in accordance with the method defined in claim 15.

76. A recorder for recording at least one of image audio stream data, navigation data and private data therein in accordance with the method defined in claim 17.

77. A recorder for recording at least one of image audio stream data, navigation data and private data therein in accordance with the method defined in claim 22.

78. A recorder for recording at least one of image audio stream data, navigation data and private data therein in accordance with the method defined in claim 24.

79. A recorder for recording at least one of image audio stream data, navigation data and private data therein in accordance with the method defined in claim 27.

80. A recorder for recording at least one of image audio stream data, navigation data and private data therein in accordance with the method defined in claim 29.

81. An apparatus for transferring at least one of image audio stream data, navigation data and private data in accordance with the method defined in claim 31.

82. An apparatus for transferring at least one of image audio stream data, navigation data and private data in accordance with the method defined in claim 40.

83. An apparatus for transferring at least one of image audio stream data, navigation data and private data in accordance with the method defined in claim 49.

84. An apparatus for receiving and recording at least one of image audio stream data, navigation data and private data in accordance with the method defined in claim 58.

85. An apparatus for receiving and recording at least one of image audio stream data, navigation data and private data in accordance with the method defined in claim 61.

86. An apparatus for receiving and recording at least one of image audio stream data, navigation data and private data in accordance with the method defined in claim 70.

87. A recording medium readable by a computer, into which at least one of a stream data file, a navigation data file and a private data file is(are) recorded in accordance with the method defined in claim 1.

88. A recording medium readable by a computer, into which at least one of a stream data file, a navigation data file and a private data file is(are) recorded in accordance with the method defined in claim 7.

89. A recording medium readable by a computer, into which at least one of a stream data file, a navigation data file and a private data file is(are) recorded in accordance with the method defined in claim 12.

90. A recording medium readable by a computer, into which at least one of a stream data file, a navigation data file and a private data file is(are) recorded in accordance with the method defined in claim 15.

91. A recording medium readable by a computer, into which at least one of a stream data file, a navigation data file and a private data file is(are) recorded in accordance with the method defined in claim 17.

92. A recording medium readable by a computer, into which at least one of a stream data file, a navigation data file and a private data file is(are) recorded in accordance with the method defined in claim 22.

93. A recording medium readable by a computer, into which at least one of a stream data file, a navigation data file and a private data file is(are) recorded in accordance with the method defined in claim 24.

94. A recording medium readable by a computer, into which at least one of a stream data file, a navigation data file and a private data file is(are) recorded in accordance with the method defined in claim 27.

95. A recording medium readable by a computer, into which at least one of a stream data file, a navigation data file and a private data file is(are) recorded in accordance with the method defined in claim 29.

96. A recording medium readable by a computer, into which at least one of image audio stream data, navigation data and private data is(are) recorded therein in accordance with the method defined in claim 31.

97. A recording medium readable by a computer, into which at least one of image audio stream data, navigation data and private data is(are) recorded therein in accordance with the method defined in claim 40.

98. A recording medium readable by a computer, into which at least one of image audio stream data, navigation data and private data is(are) recorded therein in accordance with the method defined in claim 49.
